(19) United States
(12) Patent Application Publication
(10) Pub. No.: US 2026/0241330 A1
(43) Pub. Date: Aug. 20, 2026

(54) CO2 SEPARATION SYSTEM

(71) Applicant: Panasonic Intellectual Property Management Co., Ltd., Osaka (JP)

(72) Inventors: Soichiro MINAKAMI, Aichi (JP); Tsutomu ICHIHARA, Osaka (JP)

(73) Assignee: Panasonic Intellectual Property Management Co., Ltd., Osaka (JP)

(21) Appl. No.: 19/164,546

(22) PCT Filed: Mar. 11, 2024
(86) PCT No.: PCT/JP2024/009397

§ 371 Date: Sep. 11, 2025

(30) Foreign Application Priority Data
Mar. 28, 2023 (JP) 2023-050797

(51) Int. Cl. B01D 53/22

(52) U.S. Cl. CPC B01D 53/226; B01D 2053/221; B01D 2257/504

(57) ABSTRACT

CO₂ separation system includes CO₂ separation element, CO₂ detector, inside air fan and outside air fan, and controller. CO₂ separation element separates carbon dioxide from air in target space indoors and discharges CO₂ to outdoors. CO₂ detector detects a CO₂ concentration in target space. Inside air fan and outside air fan blow air to CO₂ separation element. Controller controls inside air fan and outside air fan, and determines an air blowing amount to CO₂ separation element by inside air fan and outside air fan to achieve CO₂ separation efficiency specified based on the CO₂ concentration detected by CO₂ detector.

### TECHNICAL FIELD

The present disclosure relates to a CO₂ separation system that separates CO₂ from air in a target space.

### BACKGROUND ART

Conventionally, a carbon dioxide (CO₂) separation system that reduces the concentration of CO₂ contained in air in a closed target space is known (for example, PTL 1). The CO₂ separation system includes a module (CO₂ separation element) that preferentially separates CO₂. When air in the target space is supplied to the CO₂ separation system, CO₂ contained in the air is preferentially separated in the module and discharged, and thus air with reduced CO₂ remains. The CO₂ separation system can reduce the concentration of CO₂ in the target space by returning the remaining air to the target space.

In the CO₂ separation system, as an index indicating the performance of CO₂ separation in the CO₂ separation element, the CO₂ separation efficiency is defined by the following Formula (1).

$$\begin{matrix}[ Mathematical Formula 1 ] & \\ & Formula ( 1 )\end{matrix}$$

$$Seperation efficiency [ \% ] = \frac{\begin{matrix}{CO}_{2} concentration of target space - \\ {CO}_{2} concentration of {CO}_{2} seperation element outlet\end{matrix}}{\begin{matrix}{CO}_{2} concentration of target space - \\ {CO}_{2} concentration of outside air\end{matrix}} \times 100$$

Meanwhile, as a method of reducing the concentration of CO₂ in the target space, a method of discharging (exhausting) air (inside air) in the target space indoors to the outdoors at a constant flow amount and taking the same amount of outdoor air (outside air) into the target space (hereinafter, referred to as “normal ventilation”) is generally used.

Here, referring to FIG. 9A, a comparison is made between a CO₂ separation system, which reduces the concentration of CO₂ in the target space, and normal ventilation. FIG. 9A is a diagram indicating, with respect to a CO₂ removal amount per unit time for each of the CO₂ separation system and the normal ventilation, the power consumption necessary for removing CO₂ equal to the CO₂ removal amount. In FIG. 9A, the vertical axis represents the power consumption, and the horizontal axis represents the CO₂ removal amount per unit time. In addition, in FIG. 9A, the CO₂ separation system is indicated by a solid line, and the normal ventilation is indicated by a broken line.

In a case where a predetermined amount of CO₂ is to be discharged outdoors per unit time, the CO₂ separation system needs to take air into the CO₂ separation system with an air blowing amount equal to or more than that in the normal ventilation according to the CO₂ separation efficiency in the CO₂ separation element.

However, as indicated in FIG. 9A, when the CO₂ removal amount per unit time is set within a range of less than or equal to the predetermined amount, the CO₂ separation device has an advantage that power consumption can be significantly suppressed as compared with the normal ventilation. Since normal ventilation takes in outside air, it is necessary to air-condition the temperature of the target space according to the temperature of the outside air, and a large amount of power consumption associated with the air-conditioning is required. On the other hand, since heat transfer from inside air to outside air is small in the CO₂ separation device, the air conditioning load can be suppressed. As described above, from the viewpoint of energy saving, the CO₂ separation system is advantageous as a system for reducing the concentration of CO₂ in the target space.

### CITATION LIST

### Patent Literature

PTL 1: Japanese Translation of PCT International Application Publication No. 2006-512946

### SUMMARY OF THE INVENTION

In a case where the CO₂ concentration in a target space is high, in a CO₂ separation system, there is considered a method of increasing an air blowing amount (inside air blowing amount) of air taken into the CO₂ separation system from the target space. Here, the relationship between the inside air blowing amount and the CO₂ separation efficiency will be described with reference to FIG. 9B. FIG. 9B is a diagram indicating the parameter dependence of the CO₂ separation efficiency of the CO₂ separation system.

In FIG. 9B, the vertical axis represents the CO₂ separation efficiency of the CO₂ separation system and the horizontal axis represents a value of the parameter represented by the following Formula (2), and the relationship between the value of the parameter represented by Formula (2) and the CO₂ separation efficiency of the CO₂ separation system is indicated.

$$K / F \times P \cdot M / ρ \qquad Formula ( 2 )$$

Here, K represents a separation factor, F represents an inside air blowing amount (m³/s), P represents atmospheric pressure [kPa], M represents a CO₂ molecular weight [g/mol], and p represents a CO₂ density [g/m³]. In addition, in FIG. 9B, the ratio between a feed air amount and a sweep air amount is 1:1.

As in Formula (2), in the parameter indicated in FIG. 9B, the inside air blowing amount is in the denominator. As a result, it can be seen from FIG. 9B that the CO₂ separation efficiency decreases as the inside air blowing amount increases. This is considered to be because when the inside air blowing amount increases, CO₂ returned to the target space increases before CO₂ separation is performed by the CO₂ separation element from the air taken into the CO₂ separation system from the target space.

Therefore, in the CO₂ separation system, even if the inside air blowing amount is increased to increase the CO₂ removal amount per unit time, the increase amount of the CO₂ removal amount becomes small, and thus, as indicated in FIG. 9A, the increase rate of power consumption becomes large with respect to the increase of the CO₂ removal amount per unit time. When the CO₂ removal amount per unit time is equal to or more than a predetermined amount, the power consumption of the CO₂ separation system is rather larger than that of the normal ventilation. Therefore, the CO₂ separation system needs control for efficiently removing CO₂ from the target space.

The present disclosure has been made in view of the above circumstances, and provides a CO₂ separation system capable of efficiently removing CO₂ from a target space.

In order to achieve this object, a CO₂ separation system according to an aspect of the present disclosure includes a CO₂ separator, a CO₂ detector, an air blower, and a controller. The CO₂ separator separates carbon dioxide (CO₂) from air in a target space indoors and discharges CO₂ to the outdoors. The CO₂ detector detects the CO₂ concentration in the target space. The air blower blows air to the CO₂ separator. The controller controls the air blower to determine an air blowing amount by the air blower to the CO₂ separator so as to achieve the CO₂ separation efficiency specified based on the CO₂ concentration detected by the CO₂ detector.

According to the CO₂ separation system of the present disclosure, it is possible to efficiently remove CO₂ from the target space.

### BRIEF DESCRIPTION OF THE DRAWINGS

FIG. 1 is a schematic diagram illustrating an installation example of a CO₂ separation system according to a first exemplary embodiment of the present disclosure.

FIG. 2A is a cross-sectional view illustrating a simplified configuration of a CO₂ separation element mounted on the CO₂ separation system.

FIG. 2B is a cross-sectional view illustrating the simplified configuration of the CO₂ separation element for more efficiently separating CO₂ than FIG. 2A.

FIG. 3 is a perspective view illustrating a stacked structure used as the CO₂ separation element mounted on the CO₂ separation system.

FIG. 4 is a diagram for describing CO₂ separation efficiency specified by a controller of the CO₂ separation system based on a CO₂ concentration in a target space.

FIG. 5A is a diagram indicating an example of an inside air blowing amount of an inside air fan and an outside air blowing amount of an outside air fan which are determined with respect to the CO₂ separation efficiency specified by the controller (a case where the inside air blowing amount and the outside air blowing amount are “1:1”).

FIG. 5B is a diagram indicating an example of the inside air blowing amount of the inside air fan and the outside air blowing amount of the outside air fan which are determined with respect to the CO₂ separation efficiency specified by the controller (a case where a ratio between the inside air blowing amount and the outside air blowing amount is changed).

FIG. 5C is a diagram indicating an example of the inside air blowing amount of the inside air fan and the outside air blowing amount of the outside air fan which are determined with respect to the CO₂ separation efficiency specified by the controller (a case where the outside air blowing amount is fixed and then the inside air blowing amount is adjusted with respect to the specified CO₂ separation efficiency).

FIG. 6 is a flowchart indicating a part of air blower control processing executed by the controller.

FIG. 7 is a flowchart indicating continuation of the air blower control processing from FIG. 6.

FIG. 8A is a diagram for describing power consumption specified, based on a CO₂ concentration in a target space, by a controller of a CO₂ separation system according to a second exemplary embodiment of the present disclosure.

FIG. 8B is a diagram indicating an example of an inside air blowing amount of an inside air fan and an outside air blowing amount of an outside air fan which are determined with respect to the power consumption specified by the controller.

FIG. 9A is a diagram indicating, with respect to a CO₂ removal amount per unit time for each of the CO₂ separation system and normal ventilation, the power consumption necessary for removing CO₂ equal to the CO₂ removal amount.

FIG. 9B is a diagram indicating the parameter dependence of the CO₂ separation efficiency of the CO₂ separation system.

### DESCRIPTION OF EMBODIMENT

Hereinafter, exemplary embodiments of the present disclosure will be described with reference to the accompanying drawings. Note that the exemplary embodiments described below indicate preferred specific examples of the present disclosure. Thus, numerical values, shapes, materials, components, placement positions and connection forms of the components, and the like, which are described in each of the following exemplary embodiments, are examples and are not to limit the scope of the present disclosure. Accordingly, among the components in each of the following exemplary embodiments, the components that are not recited in the independent claims representing the most superordinate concept of the present disclosure are described herein as optional components. In addition, in each drawing, substantially the same components are denoted by the same reference numerals, and redundant description will be omitted or simplified.

### First Exemplary Embodiment

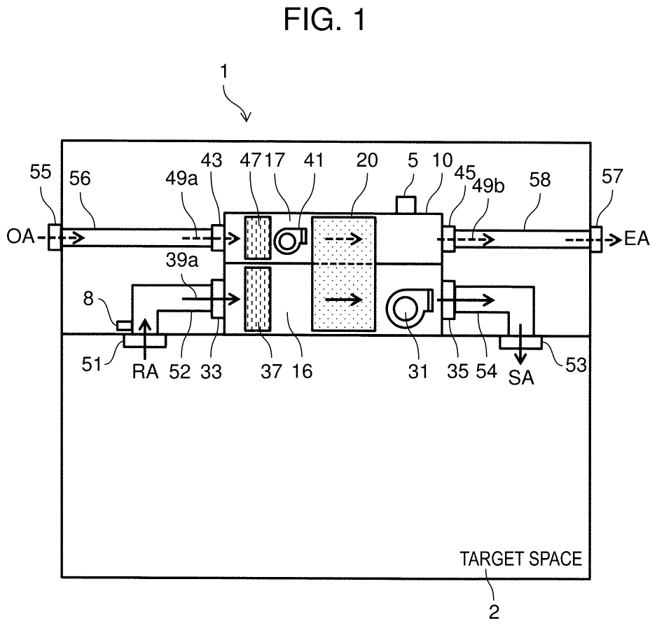

First, a schematic configuration of CO₂ separation system 1 according to a first exemplary embodiment of the present disclosure will be described with reference to FIG. 1. FIG. 1 is a schematic diagram illustrating an installation example of CO₂ separation system 1. CO₂ separation system 1 is a system that is installed indoors in a building such as a house, separates a target gas (for example, carbon dioxide (CO₂) or the like) from air 39a in target space 2 indoors, and discharges the target gas to the outdoors.

CO₂ separation system 1 includes housing 10, CO₂ separation element 20, inside air passage 16, inside air fan 31, inside air filter 37, outside air passage 17, outside air fan 41, outside air filter 47, controller 5, and CO₂ detector 8.

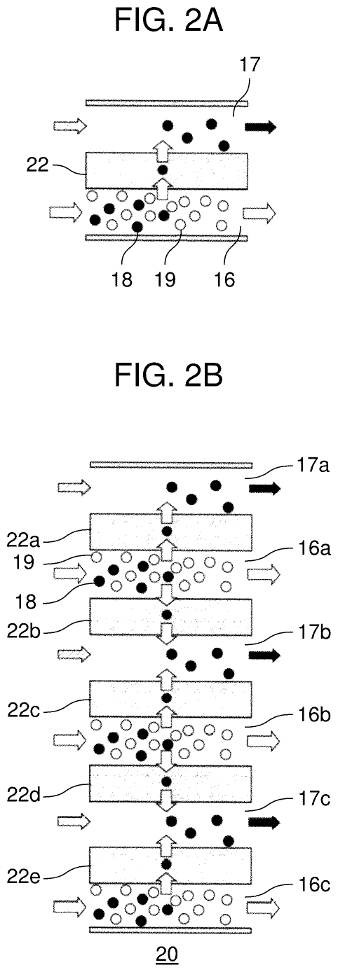

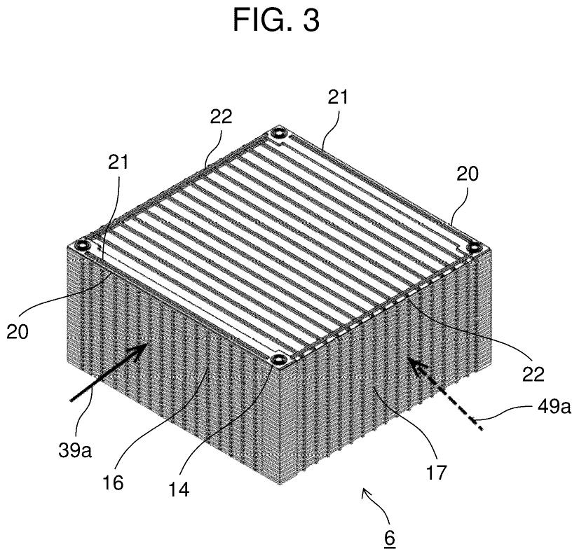

Housing 10 is an outer frame of CO₂ separation system 1. Inside air passage 16 and outside air passage 17 are independently formed so as to divide an internal space formed inside housing 10. In addition, CO₂ separation element 20 is an element that is installed inside housing 10 over inside air passage 16 and outside air passage 17, separates CO₂ from air 39a circulating through inside air passage 16, and discharges the separated CO₂ into air 49a circulating through outside air passage 17. CO₂ separation element 20 corresponds to an example of a CO₂ separator of the present disclosure. Details of CO₂ separation element 20 will be described later with reference to FIGS. 2A, 2B, and 3.

Inside air passage 16 is an air passage into which air 39a in target space 2 from which CO₂ is to be removed indoors is introduced and circulated, and through which air 39b whose CO₂ concentration has been reduced from air 39a by CO₂ separation element 20 is returned to target space 2. In the following description, air 39a and air 39b are also collectively referred to as “inside air”.

Outside air passage 17 is an air passage into which air 49a from outdoors is introduced and circulated, and through which air 49b having the CO₂ concentration increased by CO₂ separation element 20 with respect to air 49a is discharged to the outdoors. In the following description, air 49a and air 49b are also collectively referred to as “outside air”.

On an outer periphery of housing 10, inside air port 33, air supply port 35, outside air port 43, and exhaust port 45 are disposed. Inside air port 33 is a suction port through which air 39a in target space 2 indoors is sucked into inside air passage 16 of CO₂ separation system 1 as inside air. Inside air port 33 is communicated and connected to indoor suction port 51 through inside air introduction duct 52.

Indoor suction port 51 is an opening provided in target space 2 indoors, and sucks air 39a in target space 2 as return air (RA). Inside air introduction duct 52 is a duct that guides air 39a in target space 2 sucked through indoor suction port 51 to inside air port 33. One end of inside air introduction duct 52 is connected to indoor suction port 51, and air 39a in target space 2 flows into inside air introduction duct 52 as RA. The other end of inside air introduction duct 52 is connected to inside air port 33, and allows RA to flow into inside air passage 16. That is, inside air introduction duct 52 introduces air 39a in target space 2 indoors as inside air into inside air passage 16 and makes air 39a to be circulated.

Air supply port 35 is a discharge port through which air 39b as inside air having a CO₂ concentration reduced by CO₂ separation element 20 is discharged from CO₂ separation system 1. Air supply port 35 is communicated and connected to indoor blow port 53 through inside air blow duct 54.

Indoor blow port 53 is an opening provided in target space 2 indoors, and supplies air 39b having a reduced CO₂ concentration to target space 2 as supply air (SA). Inside air blow duct 54 is a duct that guides air 39b blown out from CO₂ separation system 1 to indoor blow port 53. One end of inside air blow duct 54 is connected to air supply port 35, and air 39b whose CO₂ concentration has been reduced by CO₂ separation element 20 flows into inside air blow duct 54. The other end of inside air blow duct 54 is connected to indoor blow port 53, and supplies air 39b in inside air blow duct 54 to target space 2 as SA. That is, through inside air blow duct 54, air 39b is returned to target space 2.

Outside air port 43 is a suction port through which air 49a from outdoors is sucked into outside air passage 17 of CO₂ separation system 1 as outside air. Outside air port 43 is communicated and connected to outdoor suction port 55 through outside air introduction duct 56.

Outdoor suction port 55 is an opening provided in an outer wall of a building, and sucks air 49a from outdoors as outside air (OA). Outside air introduction duct 56 is a duct that guides air 49a sucked through outdoor suction port 55 to outside air port 43. One end of outside air introduction duct 56 is connected to outdoor suction port 55, and air 49a from the outdoors flows into outside air introduction duct 56 as OA. The other end of outside air introduction duct 56 is connected to outside air port 43, and allows OA to flow into outside air passage 17. That is, outside air introduction duct 56 introduces air 49a from outdoors as outside air into outside air passage 17 and makes air 49a to be circulated.

Exhaust port 45 is a discharge port through which air 49b as outside air in which CO₂ is increased by CO₂ separation element 20 is discharged from CO₂ separation system 1. Exhaust port 45 is communicated and connected to outdoor blow port 57 through outside air blow duct 58.

Outdoor blow port 57 is an opening provided in an outer wall of the building, and exhausts air 49b having an increased CO₂ concentration to the outdoors as exhaust air (EA). Outside air blow duct 58 is a duct that guides air 49b blown out from CO₂ separation system 1 to outdoor blow port 57. One end of outside air blow duct 58 is connected to exhaust port 45, and air 49b whose CO₂ concentration has been increased by CO₂ separation element 20 flows into outside air blow duct 58. The other end of outside air blow duct 58 is connected to outdoor blow port 57, and exhausts air 49b in outside air blow duct 58 to the outdoors as EA. That is, through outside air blow duct 58, air 49b is discharged to the outdoors.

Note that inside air introduction duct 52 and inside air blow duct 54 may be combined with inside air passage 16 as an “inside air passage”, and outside air introduction duct 56 and outside air blow duct 58 may be combined with outside air passage 17 as an “outside air passage”.

Inside air fan 31 is an air blow machine that blows inside air in inside air passage 16 by, for example, being attached to a downstream side of CO₂ separation element 20, sucking the inside air from target space 2 through inside air port 33, and discharging the inside air to target space 2 through air supply port 35, in inside air passage 16. Inside air fan 31 corresponds to one specific example of an air blower of the present disclosure.

The inside air sucked from target space 2 through inside air port 33 by driving inside air fan 31 passes through inside air filter 37 and is blown to CO₂ separation element 20, and is further discharged to target space 2 through air supply port 35.

Note that inside air fan 31 may be attached to an upstream side of CO₂ separation element 20, and may be further attached to a downstream side of inside air filter 37 and to the upstream side of CO₂ separation element 20.

Inside air filter 37 is a filter that removes dust and dirt from inside air flowing into housing 10 and supplies cleaned air 39a to CO₂ separation element 20. As inside air filter 37, for example, a high efficiency particulate air (HEPA) filter or the like is used.

Outside air fan 41 is an air blow machine that blows outside air in outside air passage 17 by being attached to outside air passage 17, sucking the outside air from the outdoors through outside air port 43, and discharging the outside air to the outdoors through exhaust port 45. Outside air fan 41 corresponds to one specific example of an air blower of the present disclosure.

The outside air sucked from the outdoors through outside air port 43 by driving outside air fan 41 passes through outside air filter 47 and is blown to CO₂ separation element 20, and is further discharged to the outdoors through exhaust port 45.

Note that outside air fan 41 is attached to, for example, the upstream side of CO₂ separation element 20, preferably to a downstream side of outside air filter 47 and to the upstream side of CO₂ separation element 20. With such an arrangement, outside air can be heated by heat generated by the operation of outside air fan 41, and heat loss due to heat exchange between outside air and inside air is reduced in a case where outside air has a lower temperature than inside air. However, outside air fan 41 may be attached behind CO₂ separation element 20.

Outside air filter 47 is a filter that removes dust and dirt from outside air flowing into housing 10 and supplies cleaned air 49a to CO₂ separation element 20, and examples thereof include a HEPA filter or the like.

Here, an outline of separation of CO₂ by CO₂ separation element 20 will be described with reference to FIGS. 2A, 2B, and 3. First, FIG. 2A is a cross-sectional view illustrating a simplified configuration of CO₂ separation element 20. In FIG. 2A, inside air passage 16 through which inside air circulates from the left side toward the right side and outside air passage 17 through which outside air circulates from the left side toward the right side are illustrated by being disposed and overlapped with each other in the vertical direction.

In CO₂ separation element 20, CO₂ separation membrane 22 is disposed between inside air passage 16 and outside air passage 17. Carbon dioxide (CO₂) 18 and nitrogen (N₂) 19 are mixed in the inside air introduced into inside air passage 16. Although oxygen (O₂) and the like are also mixed in the actual air, O₂ and the like are omitted here for clear description.

When inside air circulates through inside air passage 16 along CO₂ separation membrane 22, CO₂ separation membrane 22 selectively separates (transmits) CO₂ 18 in the inside air, and discharges CO₂ 18 to outside air in outside air passage 17. As a result, the concentration of CO₂ 18 in inside air decreases and the concentration of CO₂ 18 in outside air increases.

FIG. 2B is a cross-sectional view illustrating the simplified configuration of CO₂ separation element 20 for more efficiently separating CO₂ 18 than FIG. 2A. CO₂ separation element 20 illustrated in FIG. 2B includes first inside air passage 16a to third inside air passage 16c collectively referred to as inside air passage 16, first outside air passage 17a to third outside air passage 17c collectively referred to as outside air passage 17, and first CO₂ separation membrane 22a to fifth CO₂ separation membrane 22e collectively referred to as CO₂ separation membrane 22. Note that the number of each of inside air passages 16 and the number of outside air passages 17 are not limited to “3”.

In FIG. 2B, from the upper side to the lower side, first outside air passage 17a, first inside air passage 16a, second outside air passage 17b, second inside air passage 16b, third outside air passage 17c, and third inside air passage 16c are disposed in this order.

In addition, first CO₂ separation membrane 22a is disposed between first outside air passage 17a and first inside air passage 16a. Second CO₂ separation membrane 22b is disposed between first inside air passage 16a and second outside air passage 17b. Third CO₂ separation membrane 22c is disposed between second outside air passage 17b and second inside air passage 16b. Fourth CO₂ separation membrane 22d is disposed between second inside air passage 16b and third outside air passage 17c. Fifth CO₂ separation membrane 22e is disposed between third outside air passage 17c and third inside air passage 16c.

Similar to FIG. 2A, CO₂ 18 in inside air circulating through inside air passage 16 is selectively separated (transmitted) through CO₂ separation membrane 22 to be discharged to outside air in outside air passage 17.

FIG. 3 is a perspective view illustrating stacked structure 6 used as CO₂ separation element 20 mounted on CO₂ separation system 1. Hereinafter, description will be made assuming that the stacking direction of stacked structure 6 is the vertical direction, which does not necessarily indicate the direction in the state where stacked structure 6 is mounted on CO₂ separation system 1.

In stacked structure 6, rectangular frames 14 and rectangular CO₂ separation element pieces 21 constituted by CO₂ separation membrane 22 are alternately stacked in the vertical direction, and inside air passages 16 and outside air passages 17 intersecting inside air passages 16 are alternately configured one by one.

More specifically, stacked structure 6 is configured as follows: CO₂ separation element piece 21 is fitted from both upper and lower surfaces thereof at the end of frame 14, and CO₂ separation element pieces 21 and frames 14 are repeatedly stacked.

When CO₂ separation element piece 21 is fitted from both upper and lower surfaces thereof at frame 14, frames 14 are orthogonally stacked to alternate one stage at a time. With such a configuration, as illustrated in FIG. 2B, inside air passages 16 through which inside air is ventilated and outside air passages 17 through which outside air is ventilated are alternately formed. Then, air 39a taken in from target space 2 is made to circulate through inside air passage 16 and air 49a taken in from the outdoors is made to circulate through outside air passage 17, so that the inside air flow and the outside air flow alternately and orthogonally flow through the respective air passages.

As described above, in stacked structure 6, inside air and outside air alternately flow orthogonally in the stacking direction of CO₂ separation element pieces 21. As a result, CO₂ separation element 20 allows CO₂ to selectively transmit from the inside air side to the outside air side through CO₂ separation membrane 22 of CO₂ separation element piece 21.

CO₂ separation element piece 21 is a sheet-like member constituted by CO₂ separation membrane 22, for transmitting CO₂ from inside air to outside air when inside air and outside air flow with CO₂ separation element piece 21 interposed therebetween. Since CO₂ separation element piece 21 is fitted and bent by frame 14, it is preferable to use a member having stretchability and strength that can withstand the bending.

Returning to FIG. 1, the description of CO₂ separation system 1 will be continued. CO₂ detector 8 is attached to inside air introduction duct 52, and detects the concentration of CO₂ in air 39a circulating through inside air introduction duct 52. Air 39a circulating through inside air introduction duct 52 is air taken in from target space 2. Therefore, the concentration of CO₂ detected by CO₂ detector 8 corresponds to the CO₂ concentration in target space 2.

The information on the CO₂ concentration in target space 2 detected by CO₂ detector 8 is sent to controller 5. Note that CO₂ detector 8 may be directly attached to target space 2, detect the CO₂ concentration in target space 2, and send the detected CO₂ concentration in target space 2 to controller 5.

Controller 5 controls inside air fan 31 and outside air fan 41. Specifically, based on the CO₂ concentration in target space 2 detected by CO₂ detector 8, controller 5 specifies the CO₂ separation efficiency of CO₂ separation element 20 for reducing the CO₂ concentration from target space 2 having the CO₂ concentration. Controller 5 determines an air blowing amount (inside air blowing amount) of inside air fan 31 and an air blowing amount (outside air blowing amount) of outside air fan 41 so as to achieve the specified CO₂ separation efficiency. Then, controller 5 controls inside air fan 31 so as to achieve the determined inside air blowing amount, and controls outside air fan 41 so as to achieve the determined outside air blowing amount.

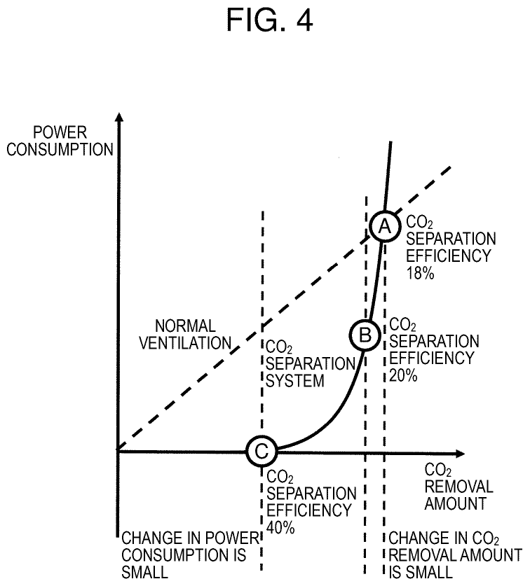

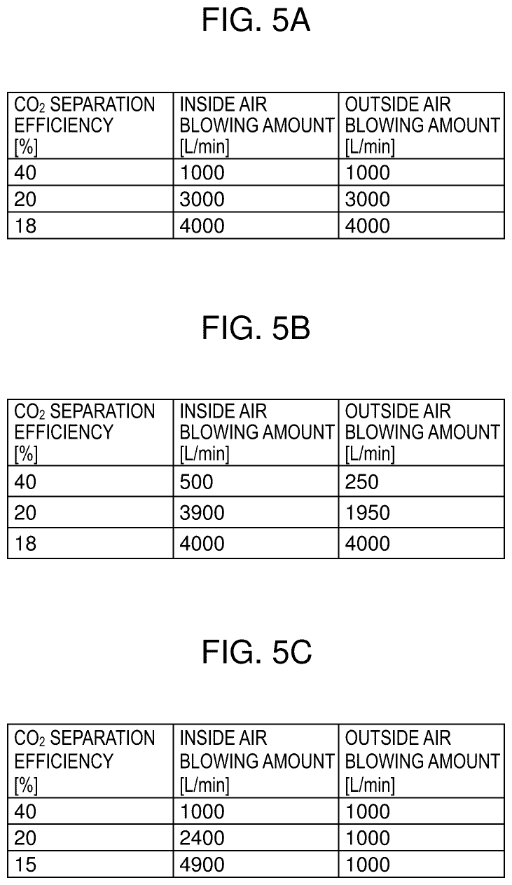

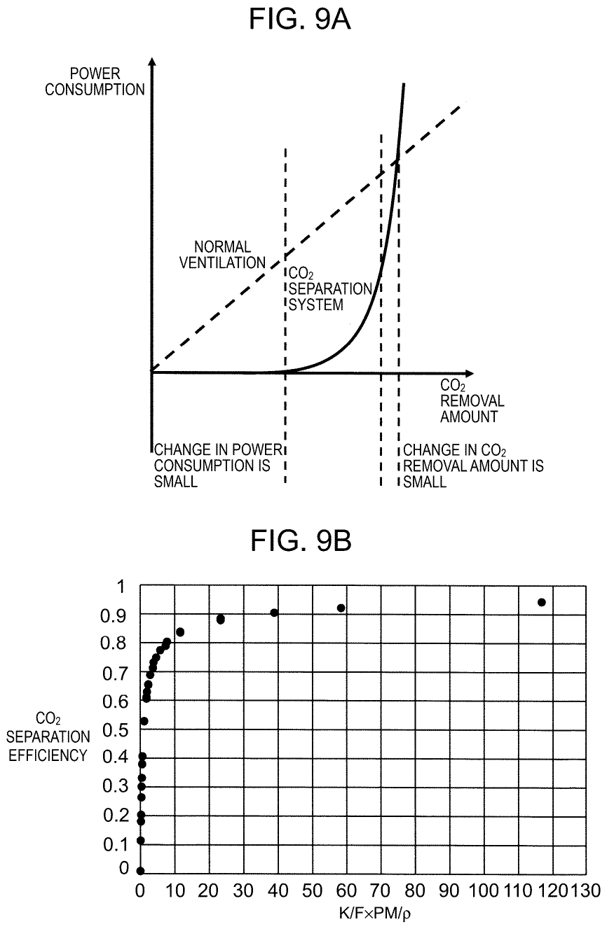

Here, an example of a method of controlling, by controller 5, the inside air blowing amount of inside air fan 31 and the outside air blowing amount of outside air fan 41 based on the CO₂ separation efficiency will be described with reference to FIGS. 4 and 5A to 5C. FIG. 4 is a diagram for describing the CO₂ separation efficiency specified by controller 5 based on the CO₂ concentration in target space 2, using the diagram indicated in FIG. 9A.

As indicated in FIG. 4, for example, controller 5 specifies the CO₂ separation efficiency of CO₂ separation element 20 based on the CO₂ concentration in target space 2 from among three of CO₂ separation efficiency A, CO₂ separation efficiency B, and CO₂ separation efficiency C. That is, in a case where the CO₂ concentration in target space 2 is high, the CO₂ separation efficiency with a high CO₂ removal amount per unit time is specified. In addition, in a case where the CO₂ concentration in target space 2 is low, the CO₂ separation efficiency with a low CO₂ removal amount per unit time is specified.

CO₂ separation efficiency A, CO₂ separation efficiency B, and CO₂ separation efficiency C are set in advance at a design phase of CO₂ separation system 1. For example, CO₂ separation efficiency B is set to 20% and CO₂ separation efficiency C is set to 40%. In addition, CO₂ separation efficiency A is set to CO₂ separation efficiency (18% in the example indicated in FIG. 4) at which power consumption matches that of normal ventilation having equivalent CO₂ removal performance (CO₂ removal rate per unit time).

Here, CO₂ separation efficiency B and CO₂ separation efficiency C are set to CO₂ separation efficiency higher than the CO₂ separation efficiency A. As described above with reference to FIGS. 9A and 9B, since CO₂ separation system 1 requires smaller inside air blowing amount as the CO₂ separation efficiency gets higher, power consumption can be suppressed. Controller 5 specifies the CO₂ separation efficiency of CO₂ separation element 20 to be equal to or higher than CO₂ separation efficiency A, whereby CO₂ separation system 1 can achieve energy saving as compared with normal ventilation.

Note that CO₂ separation efficiency A to CO₂ separation efficiency C are appropriately set according to the characteristics of CO₂ separation element 20, and are not limited to the above numerical values.

The relationship between the CO₂ separation efficiency and the CO₂ concentration in target space 2 is defined as follows at the design phase of CO₂ separation system 1. First, the CO₂ removal amount per unit time at CO₂ separation efficiency B is defined to be a “removal amount with which a reference concentration of CO₂ can be maintained at 1000 ppm in a case where there are N people in target space 2”.

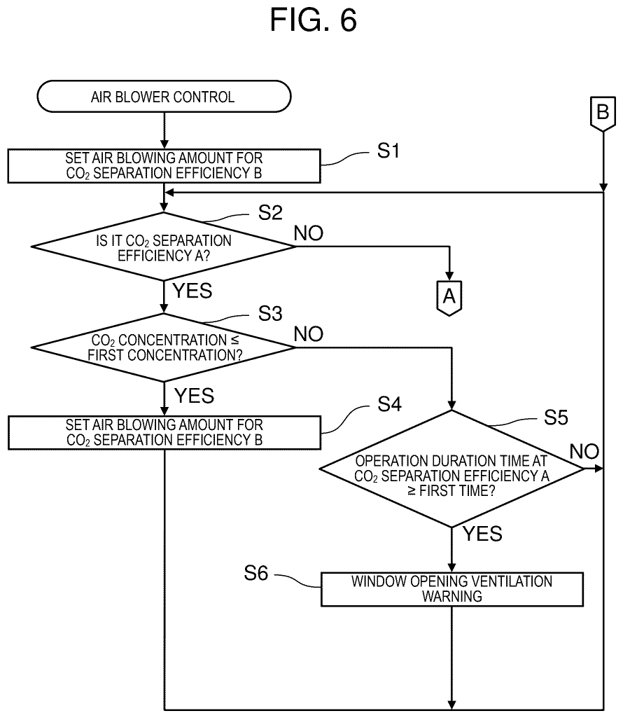

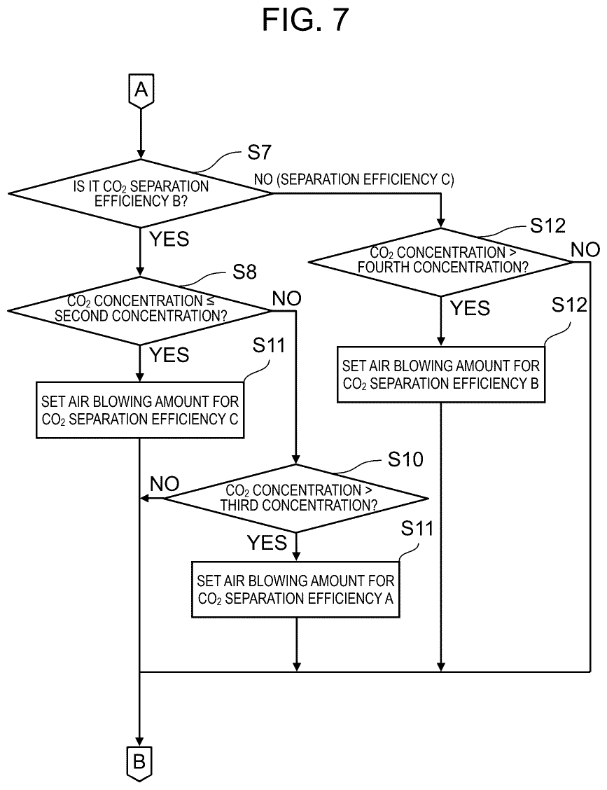

As a result, the membrane size of CO₂ separation membrane 22 of CO₂ separation element 20 is also determined at the design phase of CO₂ separation system 1. Then, the CO₂ concentration in target space 2 to be switched from CO₂ separation efficiency C to CO₂ separation efficiency B (the fourth concentration in step S12 in the flowchart indicated in FIG. 7 to be described later) is defined to 1000 ppm. In addition, the CO₂ concentration in target space 2 to be switched from CO₂ separation efficiency A to CO₂ separation efficiency B (the first concentration in step S3 in the flowchart indicated in FIG. 6 to be described later) is defined to 1000 ppm.

Meanwhile, the CO₂ concentration in target space 2 to be switched from CO₂ separation efficiency B to CO₂ separation efficiency C (the second concentration in step S8 in the flowchart indicated in FIG. 7 to be described later) can be defined to 1000 ppm. However, in a case where the CO₂ concentration in target space 2 to be switched from CO₂ separation efficiency C to CO₂ separation efficiency B and the CO₂ concentration in target space 2 to be switched from CO₂ separation efficiency B to CO₂ separation efficiency C are the same 1000 ppm, the following problem may occur. That is, when the CO₂ concentration in target space 2 is around 1000 ppm, there is a possibility that the CO₂ separation efficiency specified by controller 5 frequently switches between CO₂ separation efficiency B and CO₂ separation efficiency C.

Therefore, the CO₂ concentration in target space 2 to be switched from CO₂ separation efficiency B to CO₂ separation efficiency C (the second concentration in step S8 in the flowchart indicated in FIG. 7 to be described later) may be defined from the following Formula (3).

$$\begin{matrix}[ Mathematical Formula 2 ] & \\ Second concentration = \frac{Inside air blowing amount C}{Inside air blowing amount B} \times \frac{{CO}_{2} seperation efficiency C}{{CO}_{2} seperation efficiency B} \times ( Fourth concentration - Outside air concentration ) + Outside air concentration & Formula ( 3 )\end{matrix}$$

Here, inside air blowing amount B is an inside air blowing amount of inside air fan 31 determined such that CO₂ separation element 20 has CO₂ separation efficiency B. In addition, inside air blowing amount C is an inside air blowing amount of inside air fan 31 determined such that CO₂ separation element 20 has CO₂ separation efficiency C. Furthermore, an outside air concentration is a CO₂ concentration in outside air, and is, for example, 400 ppm.

In addition, the CO₂ concentration in target space 2 to be switched from CO₂ separation efficiency B to CO₂ separation efficiency A (the third concentration in step S10 in the flowchart indicated in FIG. 7 to be described later) is defined to 1200 ppm, for example.

Controller 5 compares the first concentration to the fourth concentration defined as described above with the CO₂ concentration in target space 2, and specifies the CO₂ separation efficiency of CO₂ separation element 20 from among CO₂ separation efficiency A to CO₂ separation efficiency C. Then, controller 5 determines the inside air blowing amount of inside air fan 31 and the outside air blowing amount of outside air fan 41 so as to achieve the specified CO₂ separation efficiency, and controls inside air fan 31 and outside air fan 41 so as to achieve the determined inside air blowing amount and outside air blowing amount, respectively.

FIGS. 5A to 5C are diagrams indicating examples of the inside air blowing amount of inside air fan 31 and the outside air blowing amount of outside air fan 41 which are determined with respect to the CO₂ separation efficiency specified by controller 5. For example, FIG. 5A is an example in which controller 5 determines the inside air blowing amount and the outside air blowing amount such that the inside air blowing amount of inside air fan 31 and the outside air blowing amount of outside air fan 41 become “1:1”. In this example, controller 5 sets both the inside air blowing amount and the outside air blowing amount to 1000 L/min with respect to CO₂ separation efficiency C (40%). In addition, controller 5 sets both the inside air blowing amount and the outside air blowing amount to 3000 L/min with respect to CO₂ separation efficiency B (20%). Furthermore, controller 5 sets both the inside air blowing amount and the outside air blowing amount to 4000 L/min with respect to CO₂ separation efficiency A (18%).

Note that, in this example, the CO₂ concentration in target space 2 switched from CO₂ separation efficiency B (20%) to CO₂ separation efficiency C (40%) (the second concentration in step S8 in the flowchart indicated in FIG. 7 to be described later) may be set to 800 ppm using the above Formula (3).

Controller 5 does not need to fix the ratio between the inside air blowing amount of inside air fan 31 and the outside air blowing amount of outside air fan 41, which is determined with respect to the specified CO₂ separation efficiency, to “1:1”, and may fix the ratio to another ratio (for example, “2:1”).

In addition, as indicated in FIG. 5B, controller 5 may change the ratio between the inside air blowing amount of inside air fan 31 and the outside air blowing amount of outside air fan 41. For example, controller 5 sets the ratio between the inside air blowing amount and the outside air blowing amount with respect to CO₂ separation efficiency C (40%) to “2:1”, and sets the inside air blowing amount to 500 L/min and the outside air blowing amount to 250 L/min. In addition, controller 5 sets the ratio between the inside air blowing amount and the outside air blowing amount with respect to CO₂ separation efficiency B (20%) to “2:1”, and sets the inside air blowing amount to 3900 L/min and the outside air blowing amount to 1950 L/min. Meanwhile, controller 5 sets the ratio between the inside air blowing amount and the outside air blowing amount with respect to CO₂ separation efficiency A (18%) to “1:1”, and sets the inside air blowing amount to 4000 L/min and the outside air blowing amount to 4000 L/min.

Note that, in this example, the CO₂ concentration in target space 2 switched from CO₂ separation efficiency B (20%) to CO₂ separation efficiency C (40%) (the second concentration in step S8 in the flowchart indicated in FIG. 7 to be described later) may be set to 554 ppm using the above Formula (3).

In addition, as indicated in FIG. 5C, controller 5 fixes the outside air blowing amount of outside air fan 41 to 1000 L/min, and then may adjust only the inside air blowing amount of inside air fan 31 with respect to the specified CO₂ separation efficiency. For example, controller 5 sets the inside air blowing amount to 1000 L/min with respect to CO₂ separation efficiency C (40%). In addition, controller 5 sets the inside air blowing amount to 2400 L/min with respect to CO₂ separation efficiency B (20%). Furthermore, controller 5 sets the inside air blowing amount to 4900 L/min with respect to CO₂ separation efficiency A (example in FIG. 5C indicates a case of 15%).

Note that, in this example, the CO₂ concentration in target space 2 switched from CO₂ separation efficiency B (20%) to CO₂ separation efficiency C (40%) (the second concentration in step S8 in the flowchart indicated in FIG. 7 to be described later) may be set to 900 ppm using the above Formula (3).

Controller 5 includes tables, as indicated in FIGS. 5A to 5C, which indicate the inside air blowing amount of inside air fan 31 and the outside air blowing amount of outside air fan 41 for achieving the CO₂ separation efficiency in association with the CO₂ separation efficiency that can be specified by controller 5. When controller 5 specifies the CO₂ separation efficiency based on the CO₂ concentration in target space 2, controller 5 determines the inside air blowing amount of inside air fan 31 and the outside air blowing amount of outside air fan 41 corresponding to the specified CO₂ separation efficiency from the tables. Controller 5 controls inside air fan 31 and outside air fan 41 so as to achieve the determined inside air blowing amount and outside air blowing amount.

Note that, in the case of the example indicated in FIG. 5C, since the outside air blowing amount of outside air fan 41 is fixed, controller 5 may use a table indicating only the inside air blowing amount of inside air fan 31 for achieving the CO₂ separation efficiency in association with the identifiable CO₂ separation efficiency. When controller 5 specifies the CO₂ separation efficiency based on the CO₂ concentration in target space 2, controller 5 determines the inside air blowing amount of inside air fan 31 corresponding to the specified CO₂ separation efficiency from the table. Controller 5 controls inside air fan 31 so as to achieve the determined inside air blowing amount. In addition, controller 5 controls outside air fan 41 so as to achieve the outside air blowing amount fixed in advance.

Next, a flow of control of inside air fan 31 and outside air fan 41 by controller 5 will be described with reference to FIGS. 6 and 7. FIG. 6 is a flowchart indicating a part of air blower control processing executed by controller 5, and FIG. 7 is a flowchart indicating the continuation of the air blower control processing from FIG. 6. Note that, in the following description of the air blower control processing, “less than or equal to” may be read as “less than”, “greater than” may be read as “equal to or greater than”, “equal to or greater than” may be read as “greater than”, and “less than” may be read as “less than or equal to”.

The air blower control processing is processing executed by controller 5 in a case where a user instructs CO₂ separation system 1 to execute the CO₂ removal in target space 2. The air blower control processing controls the inside air blowing amount of inside air fan 31 and the outside air blowing amount of outside air fan 41 based on the CO₂ concentration in target space 2.

When the execution of the air blower control processing is started, controller 5 first determines the inside air blowing amount of inside air fan 31 and the outside air blowing amount of outside air fan 41 such that the CO₂ separation efficiency of CO₂ separation element 20 becomes CO₂ separation efficiency B (20%), as an initial setting (step S1). Then, controller 5 controls inside air fan 31 and outside air fan 41 so as to achieve the determined inside air blowing amount and outside air blowing amount.

Here, in the air blower control processing, controller 5 determines the inside air blowing amount of inside air fan 31 and the outside air blowing amount of outside air fan 41 corresponding to the CO₂ separation efficiency by using the tables indicated in FIGS. 5A to 5C.

Note that, in the processing of step S1, the CO₂ separation efficiency as an initial setting may be specified based on the CO₂ concentration in target space 2 detected by CO₂ detector 8. For example, in a case where the CO₂ concentration in target space 2 is less than 1000 ppm, the CO₂ separation efficiency may be specified as CO₂ separation efficiency C (40%). In addition, in a case where the CO₂ concentration in target space 2 is equal to or greater than 1000 ppm and less than 1200 ppm, the CO₂ separation efficiency may be specified as CO₂ separation efficiency B (20%). Furthermore, in a case where the CO₂ concentration in target space 2 is equal to or greater than 1200 ppm, the CO₂ separation efficiency may be specified as CO₂ separation efficiency A (18%). Controller 5 may determine the inside air blowing amount of inside air fan 31 and the outside air blowing amount of outside air fan 41 so as to achieve the specified CO₂ separation efficiency.

Next, controller 5 determines whether the current CO₂ separation efficiency of CO₂ separation element 20 is CO₂ separation efficiency A (18%) (step S2). As a result, when determining that the CO₂ separation efficiency is CO₂ separation efficiency A (step S2: Yes), controller 5 then acquires the CO₂ concentration in target space 2 detected by CO₂ detector 8, and determines whether the CO₂ concentration is less than or equal to the first concentration (for example, 1000 ppm) (step S3).

As a result, when determining that the CO₂ concentration is less than or equal to the first concentration (step S3: Yes), controller 5 determines the CO₂ separation efficiency of CO₂ separation element 20 corresponding to the CO₂ concentration as CO₂ separation efficiency B (20%), and decreases the CO₂ removal amount per unit time (step S4). Then, controller 5 determines the inside air blowing amount of inside air fan 31 and the outside air blowing amount of outside air fan 41 corresponding to CO₂ separation efficiency B (20%), and controls inside air fan 31 and outside air fan 41 so as to achieve the determined inside air blowing amount and outside air blowing amount, respectively. Thereafter, controller 5 returns to the processing of step S2.

On the other hand, when determining that the CO₂ concentration is greater than the first concentration (for example, 1000 ppm) as a result of the determination in step S3 (step S3: No), controller 5 maintains the CO₂ separation efficiency of CO₂ separation element 20 corresponding to the CO₂ concentration at CO₂ separation efficiency A (18%), and then performs the determination in step S5. In the determination in step S5, controller 5 determines an operation duration time at CO₂ separation efficiency A (18%), and determines whether the operation duration time is equal to or greater than the first time (for example, 30 minutes) (step S5).

As a result, when it is determined that the operation duration time at CO₂ separation efficiency A (18%) is equal to or greater than the first time (for example, 30 minutes) (step S5: Yes), it means the following. That is, it means that the CO₂ concentration in target space 2 does not decrease to a concentration less than or equal to the first concentration even if CO₂ separation system 1 is operated at CO₂ separation efficiency A (18%) for a time equal to or greater than the first time. In addition, the operation at CO₂ separation efficiency A (18%) is an operation mode in which the CO₂ removal amount per unit time is the largest as compared with CO₂ separation efficiency B and CO₂ separation efficiency C.

Therefore, in this case (step S5: Yes), controller 5 notifies the user of a window opening ventilation warning (step S6), and proceeds to the processing of step S2. The window opening ventilation warning may be notified by voice, or may be notified by causing a light emitting diode provided in CO₂ separation system 1 to emit light or displaying the warning on a liquid crystal display. In addition, CO₂ separation system 1 may be capable of communicating with a portable information terminal such as a smartphone, and the window opening ventilation warning may be issued by causing the portable information terminal to display the notification to that effect.

On the other hand, when it is determined that the operation duration time at CO₂ separation efficiency A (18%) is less than the first time as a result of the determination in step S5 (step S5: No), controller 5 directly returns to the processing of step S2.

In addition, when determining that the current CO₂ separation efficiency of CO₂ separation element 20 is not CO₂ separation efficiency A as a result of the determination in step S2 (step S2: No), controller 5 proceeds to the determination in step S7 indicated in FIG. 7. In the determination in step S7, controller 5 determines whether the current CO₂ separation efficiency of CO₂ separation element 20 is CO₂ separation efficiency B (20%) (step S7).

As a result, when determining that the CO₂ separation efficiency is CO₂ separation efficiency B (step S7: Yes), controller 5 then acquires the CO₂ concentration in target space 2 detected by CO₂ detector 8, and determines whether the CO₂ concentration is less than or equal to the second concentration (for example, 800 ppm) (step S8).

As a result, when determining that the CO₂ concentration is less than or equal to the second concentration (step S8: Yes), controller 5 determines the CO₂ separation efficiency of CO₂ separation element 20 corresponding to the CO₂ concentration as CO₂ separation efficiency C (40%), and decreases the CO₂ removal amount per unit time (step S9). Then, controller 5 determines the inside air blowing amount of inside air fan 31 and the outside air blowing amount of outside air fan 41 corresponding to CO₂ separation efficiency C (40%), and controls inside air fan 31 and outside air fan 41 so as to achieve the determined inside air blowing amount and outside air blowing amount, respectively. Thereafter, controller 5 returns to the processing of step S2 indicated in FIG. 6.

On the other hand, when determining that the CO₂ concentration is greater than the second concentration as a result of the determination in step S8 (step S8: No), controller 5 then determines whether the CO₂ concentration in target space 2 detected by CO₂ detector 8 is greater than the third concentration (for example, 1000 ppm) (step S10).

As a result, when determining that the CO₂ concentration is greater than the third concentration (step S10: Yes), controller 5 determines the CO₂ separation efficiency of CO₂ separation element 20 corresponding to the CO₂ concentration as CO₂ separation efficiency A (18%), and increases the CO₂ removal amount per unit time (step S11). Then, controller 5 determines the inside air blowing amount of inside air fan 31 and the outside air blowing amount of outside air fan 41 corresponding to CO₂ separation efficiency A (18%), and controls inside air fan 31 and outside air fan 41 so as to achieve the determined inside air blowing amount and outside air blowing amount, respectively. Thereafter, controller 5 returns to the processing of step S2 indicated in FIG. 6.

On the other hand, when it is determined that the CO₂ concentration is less than or equal to the third concentration as a result of the determination in step S10 (step S10: Yes), the CO₂ concentration in target space 2 is greater than the second concentration and less than or equal to the third concentration. Therefore, controller 5 maintains the CO₂ separation efficiency of CO₂ separation element 20 corresponding to the CO₂ concentration at CO₂ separation efficiency B (20%), and then returns to the processing of step S2 indicated in FIG. 6.

In addition, when it is determined that the current CO₂ separation efficiency of CO₂ separation element 20 is not CO₂ separation efficiency B as a result of the determination in step S7 (step S7: No), the current CO₂ separation efficiency of CO₂ separation element 20 is CO₂ separation efficiency C (40%). Therefore, in this case, controller 5 acquires the CO₂ concentration in target space 2 detected by CO₂ detector 8, and determines whether the CO₂ concentration is greater than the fourth concentration (for example, 1000 ppm) (step S12).

As a result, when determining that the CO₂ concentration is greater than the fourth concentration (step S12: Yes), controller 5 determines the CO₂ separation efficiency of CO₂ separation element 20 corresponding to the CO₂ concentration as CO₂ separation efficiency B (20%), and increases the CO₂ removal amount per unit time (step S12). Then, controller 5 determines the inside air blowing amount of inside air fan 31 and the outside air blowing amount of outside air fan 41 corresponding to CO₂ separation efficiency B (20%), and controls inside air fan 31 and outside air fan 41 so as to achieve the determined inside air blowing amount and outside air blowing amount, respectively. Thereafter, controller 5 returns to the processing of step S2 indicated in FIG. 6.

In addition, when it is determined that the CO₂ concentration is less than or equal to the fourth concentration as a result of the determination in step S12 (step S12: Yes), controller 5 maintains the CO₂ separation efficiency of CO₂ separation element 20 corresponding to the CO₂ concentration at CO₂ separation efficiency C (40%), and then returns to the processing of step S2 indicated in FIG. 6.

CO₂ separation system 1 according to the first exemplary embodiment described above has the following effects.
(1) CO₂ separation system 1 separates CO₂ from air 39a in target space 2 indoors and discharges CO₂ to the outdoors by CO₂ separation element 20, thereby reducing the CO₂ concentration in target space 2. Air is blown to CO₂ separation element 20 by inside air fan 31 and outside air fan 41. CO₂ separation efficiency in CO₂ separation element 20 is determined by, for example, an air blowing amount to CO₂ separation element 20. Here, in CO₂ separation system 1, the CO₂ concentration in target space 2 is detected by CO₂ detector 8, and the necessary CO₂ separation efficiency is specified by controller 5 based on the detected CO₂ concentration. Then, in CO₂ separation system 1, the air blowing amounts of inside air fan 31 and outside air fan 41 are determined by controller 5 so as to achieve the specified CO₂ separation efficiency. As a result, CO₂ separation system 1 can specify the CO₂ separation efficiency necessary and sufficient for lowering the CO₂ concentration in target space 2, and determine the air blowing amounts of inside air fan 31 and outside air fan 41 to CO₂ separation element 20 so as to achieve the CO₂ separation efficiency. Therefore, CO₂ separation system 1 can remove CO₂ from target space 2 without consuming more power than necessary. Accordingly, CO₂ separation system 1 can efficiently remove CO₂ from target space 2.
(2) In CO₂ separation system 1, air 39a in target space 2 is introduced into and circulates through inside air passage 16 as inside air, and after CO₂ is separated by CO₂ separation element 20, returned to target space 2 as air 39b. Inside air is blown to inside air passage 16 by inside air fan 31. In addition, in CO₂ separation system 1, air 49a from outdoors is introduced into and circulates through outside air passage 17 as outside air, and after CO₂ is introduced by CO₂ separation element 20, discharged to the outdoors as air 49b. Outside air is blown to outside air passage 17 by outside air fan 41. In CO₂ separation system 1, by controller 5, at least the inside air blowing amount of inside air fan 31 is adjusted so as to achieve the CO₂ separation efficiency specified based on the CO₂ concentration in target space 2, and the air blowing amount to CO₂ separation element 20 is determined. As a result, since CO₂ separation system 1 can remove CO₂ from target space 2 without consuming more power than necessary, CO₂ can be efficiently removed from target space 2.
(3) In a case where the CO₂ concentration in target space 2 is the first CO₂ concentration less than or equal to the second concentration (see step S8 in FIG. 7), for example, controller 5 specifies the CO₂ separation efficiency as CO₂ separation efficiency C (corresponding to the first CO₂ separation efficiency of the present disclosure). In addition, in a case where the CO₂ concentration in target space 2 is the second CO₂ concentration greater than the fourth concentration (see step S12 in FIG. 7), controller 5 specifies the CO₂ separation efficiency as CO₂ separation efficiency B lower than the CO₂ separation efficiency C (corresponding to the second CO₂ separation efficiency of the present disclosure). That is, in a case where the CO₂ concentration in target space 2 is the second CO₂ concentration higher than the first CO₂ concentration, controller 5 specifies the CO₂ separation efficiency lower than the CO₂ separation efficiency specified for the first CO₂ concentration. Then, controller 5 determines the air blowing amount to CO₂ separation element 20 so as to achieve the specified CO₂ separation efficiency. As a result, in a case where the CO₂ concentration in target space 2 is low, CO₂ separation system 1 can achieve power saving by setting the CO₂ separation efficiency high and reducing the air blowing amount to CO₂ separation element 20 in accordance with the CO₂ separation efficiency. In addition, in a case where the CO₂ concentration in target space 2 is high, CO₂ separation system 1 can remove CO₂ from target space 2 without consuming more power than necessary by setting the CO₂ separation efficiency low and increasing the air blowing amount to CO₂ separation element 20 in accordance with the CO₂ separation efficiency. Accordingly, CO₂ separation system 1 can efficiently remove CO₂ from target space 2.

In addition, as described in the above description, CO₂ separation system 1 can obtain effects corresponding to each configuration.

### Second Exemplary Embodiment

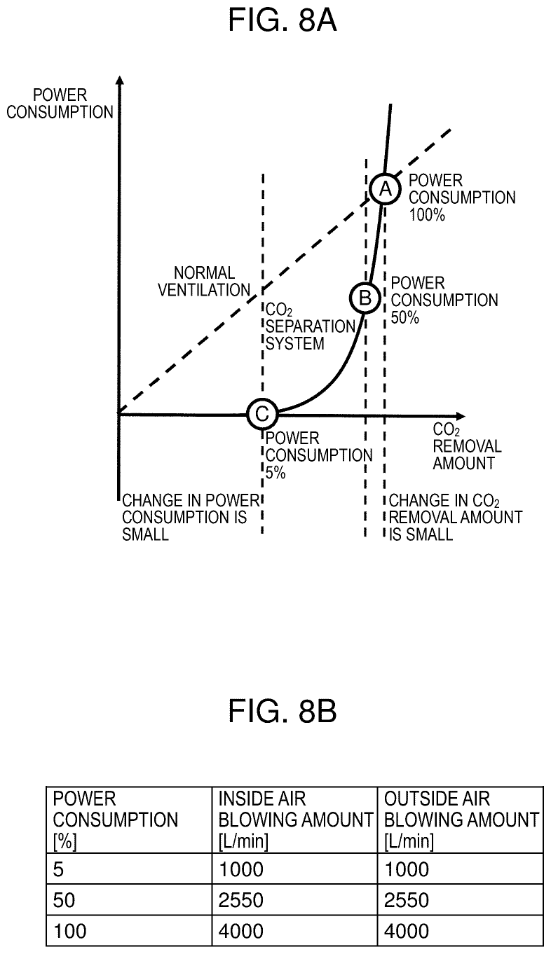

Next, CO₂ separation system 1 according to a second exemplary embodiment will be described with reference to FIGS. 8A and 8B.

In CO₂ separation system 1 according to the first exemplary embodiment, controller 5 specifies the CO₂ separation efficiency based on the CO₂ concentration in target space 2 detected by CO₂ detector 8, and determines the air blowing amounts of inside air fan 31 and outside air fan 41 so as to achieve the specified CO₂ separation efficiency.

On the other hand, in CO₂ separation system 1 according to the second exemplary embodiment, controller 5 specifies the power consumption of CO₂ separation system 1 necessary for reducing the CO₂ concentration based on the CO₂ concentration in target space 2 detected by CO₂ detector 8. Controller 5 determines an inside air blowing amount of inside air fan 31 and an outside air blowing amount of outside air fan 41 so as to achieve the specified power consumption. Then, controller 5 controls inside air fan 31 and outside air fan 41 so as to achieve the determined inside air blowing amount and outside air blowing amount.

FIG. 8A is a diagram for describing the power consumption specified, based on the CO₂ concentration in target space 2, by controller 5 of CO₂ separation system 1 according to the second exemplary embodiment of the present disclosure, using the diagram indicated in FIG. 9A.

As indicated in FIG. 8A, for example, controller 5 specifies the power consumption of CO₂ separation system 1 based on the CO₂ concentration in target space 2 from among three of power consumption A, power consumption B, and power consumption C. That is, in a case where the CO₂ concentration in target space 2 is high, the power consumption with a high CO₂ removal amount per unit time is specified, and in a case where the CO₂ concentration in target space 2 is low, the power consumption with a low CO₂ removal amount per unit time is specified.

Power consumption A, power consumption B, and power consumption C are set in advance at a design phase of CO₂ separation system 1. For example, power consumption B is 50% of power consumption A, and power consumption C is 5% of power consumption A. In addition, power consumption A is set to power consumption at which the equivalent CO₂ removal performance (CO₂ removal rate per unit time) can be obtained with the same power consumption in normal ventilation and CO₂ separation system 1.

Here, power consumption B and power consumption C are set to power consumption lower than power consumption A. As a result, controller 5 specifies the power consumption of CO₂ separation element 20 to be less than or equal to power consumption A, whereby CO₂ separation system 1 can achieve energy saving as compared with normal ventilation.

Note that power consumption B and power consumption C are appropriately set according to the characteristics of CO₂ separation element 20, and are not limited to the above numerical values.

The relationship between the power consumption and the CO₂ concentration in target space 2 is defined as follows at the design phase of CO₂ separation system 1. First, the CO₂ removal amount per unit time at power consumption B is defined to be a “removal amount with which a reference concentration of CO₂ can be maintained at 1000 ppm in a case where there are N people in target space 2”.

As a result, the membrane size of CO₂ separation membrane 22 of CO₂ separation element 20 is also determined at the design phase of CO₂ separation system 1. Then, the CO₂ concentration in target space 2 to be switched from power consumption C to power consumption B (corresponding to the fourth concentration in step S12 in the flowchart indicated in FIG. 7) is defined to 1000 ppm. In addition, the CO₂ concentration in target space 2 to be switched from power consumption A to power consumption B (corresponding to the first concentration in step S3 in the flowchart indicated in FIG. 6) is defined to 1000 ppm.

Meanwhile, the CO₂ concentration in target space 2 to be switched from power consumption B to power consumption C (corresponding to the second concentration in step S8 in the flowchart indicated in FIG. 7) can be defined to 1000 ppm. However, in a case where the CO₂ concentration in target space 2 to be switched from power consumption C to power consumption B and the CO₂ concentration in target space 2 to be switched from power consumption B to the power consumption C are the same 1000 ppm, the following problem may occur. That is, when the CO₂ concentration in target space 2 is around 1000 ppm, there is a possibility that the power consumption specified by controller 5 frequently switches between power consumption B and power consumption C.

Therefore, the CO₂ concentration in target space 2 to be switched from power consumption B to power consumption C (corresponding to the second concentration in step S8 in the flowchart indicated in FIG. 7) may be defined as follows. The CO₂ removal amount per unit time at power consumption C can be defined as “removal amount with which a reference concentration of CO₂ can be maintained at 1000 ppm in a case where there are n people in target space 2 (n<N)” with respect to the CO₂ removal amount per unit time at power consumption B. Therefore, the CO₂ concentration in target space 2 to be switched from power consumption B to power consumption C (corresponding to the second concentration in step S8 in the flowchart indicated in FIG. 7) can be defined by Formula (4).

$$Second concentration = ( n / N ) \times ( fourth concentration - outside air concentration ) + outside air concentration \qquad Formula ( 4 )$$

Here, an outside air concentration is a CO₂ concentration in outside air, and is, for example, 400 ppm. If the CO₂ removal amount per unit time at power consumption B is defined as “removal amount with which the reference concentration of CO₂ can be maintained at 1000 ppm in a case where there are four people in target space 2” (that is, N=4), and the CO₂ removal amount per unit time at power consumption C is defined as “removal amount with which the reference concentration of CO₂ can be maintained at 1000 ppm in a case where there are three people in target space 2” (that is, n=3), the CO₂ concentration (second concentration) in target space 2 to be switched from power consumption B to power consumption C is obtained as 850 ppm from Formula (4).

Controller 5 compares the first concentration to the fourth concentration defined as described above with the CO₂ concentration in target space 2, and specifies the power consumption of CO₂ separation element 20 from among power consumption A to power consumption C. Then, controller 5 determines the inside air blowing amount of inside air fan 31 and the outside air blowing amount of outside air fan 41 so as to achieve the specified power consumption, and controls inside air fan 31 and outside air fan 41 so as to achieve the determined inside air blowing amount and outside air blowing amount, respectively.

FIG. 8B is a diagram indicating an example of the inside air blowing amount of inside air fan 31 and the outside air blowing amount of outside air fan 41 which are determined with respect to the power consumption specified by controller 5. For example, FIG. 8B is an example in which controller 5 determines the inside air blowing amount and the outside air blowing amount such that the inside air blowing amount of inside air fan 31 and the outside air blowing amount of outside air fan 41 become “1:1”.

In this example, controller 5 sets both the inside air blowing amount and the outside air blowing amount to 1000 L/min with respect to power consumption C (5% of power consumption A). In addition, controller 5 sets both the inside air blowing amount and the outside air blowing amount to 2550 L/min with respect to power consumption B (50% of power consumption A). Furthermore, controller 5 sets both the inside air blowing amount and the outside air blowing amount to 4000 L/min with respect to power consumption A (100%).

Note that controller 5 does not need to fix the ratio between the inside air blowing amount of inside air fan 31 and the outside air blowing amount of outside air fan 41, which is determined with respect to the specified power consumption, to “1:1”, and may fix the ratio to another ratio (for example, “2:1”) or change the ratio by the power consumption. In addition, controller 5 fixes the outside air blowing amount of outside air fan 41, and then may adjust only the inside air blowing amount of inside air fan 31 with respect to the specified power consumption.

Controller 5 of CO₂ separation system 1 according to the second exemplary embodiment configured as described above executes processing similar to the air blower control processing indicated in the flowcharts of FIGS. 6 and 7. However, in the air blower control processing according to the second exemplary embodiment, “CO₂ separation efficiency A” is replaced with “power consumption A”, “CO₂ separation efficiency B” is replaced with “power consumption B”, and “CO₂ separation efficiency C” is replaced with “power consumption C”, as compared with the air blower control processing indicated in FIGS. 6 and 7.

CO₂ separation system 1 according to the second exemplary embodiment described above has the following effects.
(4) In CO₂ separation system 1, the CO₂ concentration in target space 2 is detected by CO₂ detector 8, and the power consumption necessary for removing CO₂ is specified by controller 5 based on the detected CO₂ concentration. Then, in CO₂ separation system 1, the air blowing amounts of inside air fan 31 and outside air fan 41 are determined by controller 5 so as to achieve the specified power consumption. As a result, CO₂ separation system 1 can specify the power consumption necessary and sufficient for lowering the CO₂ concentration in target space 2, and determine the air blowing amounts of inside air fan 31 and outside air fan 41 to CO₂ separation element 20 so as to achieve the CO₂ separation efficiency. Therefore, CO₂ separation system 1 can remove CO₂ from target space 2 without consuming more power than necessary. Accordingly, CO₂ separation system 1 can efficiently remove CO₂ from target space 2.

In addition, since CO₂ separation system 1 according to the second exemplary embodiment has the configuration similar to CO₂ separation system 1 according to the first exemplary embodiment, similar functions and effects are exhibited.

Although the present disclosure has been described above based on each of the exemplary embodiments, the present disclosure is not limited to each of the above exemplary embodiments in any way, and it can be easily inferred that various modifications and variations may be made without departing from the scope of the present disclosure. For example, each exemplary embodiment including the modification described below may be modified by adding a part or a plurality of parts of the configuration of another exemplary embodiment to this exemplary embodiment or replacing the part or the plurality of parts of the configuration of this exemplary embodiment. In addition, the numerical values mentioned in each exemplary embodiment are merely examples, and other numerical values can be naturally used.

In each of the exemplary embodiments, the outdoor air (air outside the building) is introduced as air 49a, but the present invention is not limited thereto. For example, as air 49a, air may be introduced from a ceiling portion of a building, or air from indoors such as a vacant room adjacent thereto may be introduced. Also in such configurations, air having the CO₂ concentration smaller than that of air 39a in target space 2 where a person is present and CO₂ concentration has increased can be introduced into CO₂ separation element 20 as air 49a. Therefore, it is possible to obtain a similar effect that CO₂ transfers from air 39a having a high CO₂ concentration to air 49a having a relatively low CO₂ concentration and an increase in the CO₂ concentration in target space 2 can be suppressed.

### INDUSTRIAL APPLICABILITY

The present disclosure is useful as a CO₂ separation system that can efficiently remove CO₂ in a target space where many people are present.

### REFERENCE MARKS IN THE DRAWINGS

1: CO₂ separation system
2: target space
5: controller
6: stacked structure
8: CO₂ detector
10: housing
14: frame
16: inside air passage
16a: first inside air passage
16b: second inside air passage
16c: third inside air passage
17: outside air passage
17a: first outside air passage
17b: second outside air passage
17c: third outside air passage
20: CO₂ separation element
21: CO₂ separation element piece
22: CO₂ separation membrane
22a: first CO₂ separation membrane
22b: second CO₂ separation membrane
22c: third CO₂ separation membrane
22d: fourth CO₂ separation membrane
22e: fifth CO₂ separation membrane
31: inside air fan
33: inside air port
35: air supply port
37: inside air filter
39a: air
39b: air
41: outside air fan
43: outside air port
45: exhaust port
47: outside air filter
49a: air
49b: air
51: indoor suction port
52: inside air introduction duct
53: indoor blow port
54: inside air blow duct
55: outdoor suction port
56: outside air introduction duct
57: outdoor blow port
58: outside air blow duct

1. A CO₂ separation system comprising:
a CO₂ separator that separates carbon dioxide (CO₂) from air in a target space indoors and discharges CO₂ to outdoors;
a CO₂ detector that detects a CO₂ concentration in the target space;
an air blower that blows air to the CO₂ separator; and
a controller that controls the air blower, wherein
the controller determines an air blowing amount to the CO₂ separator by the air blower to achieve a CO₂ separation efficiency specified based on the CO₂ concentration detected by the CO₂ detector.

2. The CO₂ separation system according to claim 1, comprising:
an inside air passage into which air in the target space is introduced and circulated as inside air, the inside air passage returning the air to the target space; and
an outside air passage into which air from outdoors is introduced and circulated as outside air, and is discharged to the outdoors, wherein
the air blower includes an inside air fan that blows the inside air in the inside air passage and an outside air fan that blows the outside air in the outside air passage,
the CO₂ separator separates CO₂ from the inside air circulating through the inside air passage and introduces CO₂ into the outside air circulating through the outside air passage, and
the controller determines the air blowing amount to the CO₂ separator by adjusting at least an inside air blowing amount of the inside air fan.

3. The CO₂ separation system according to claim 1, wherein
the controller specifies the CO₂ separation efficiency as a first CO₂ separation efficiency in a case where the CO₂ concentration is a first CO₂ concentration, and specifies the CO₂ separation efficiency as a second CO₂ separation efficiency lower than the first CO₂ separation efficiency in a case where the CO₂ concentration is a second CO₂ concentration higher than the first CO₂ concentration, and
the controller determines the air blowing amount to the CO₂ separator to achieve the specified CO₂ separation efficiency.

4. The CO₂ separation system according to claim 2, wherein
the controller specifies the CO₂ separation efficiency as a first CO₂ separation efficiency in a case where the CO₂ concentration is a first CO₂ concentration, and specifies the CO₂ separation efficiency as a second CO₂ separation efficiency lower than the first CO₂ separation efficiency in a case where the CO₂ concentration is a second CO₂ concentration higher than the first CO₂ concentration, and
the controller determines the air blowing amount to the CO₂ separator to achieve the specified CO₂ separation efficiency.
